(19) United States
(12) Patent Application Publication
(10) Pub. No.: US 2008/0105608 A1
(43) Pub. Date: May 8, 2008

(54) Staged Screen System

(75) Inventors: Brian Burgess, Western Australia (AU); George Burgess, Auckland (NZ)

Correspondence Address: YOUNG & THOMPSON, 209 Madison Street, Suite 500, ALEXANDRIA, VA, 22314, US

(73) Assignee: POWER- GLIDES SCREENS LIMITED, AUCKLAND (NZ)

(21) Appl. No.: 11/664,523

(22) PCT Filed: Oct. 4, 2005
(86) PCT No.: PCT/NZ05/00255

§ 371 Date: Nov. 20, 2007

(30) Foreign Application Priority Data
Oct. 4, 2004 (NZ) 535717

(51) Int. Cl. B01D 35/30

(52) U.S. Cl. 210/405

(57) ABSTRACT

A staged screen system for the removal of solids or floatables or any unwanted debris from a suspension or fluid flow. The system includes an apparatus which has a first screen, a second screen, and at least one moveable rake element. The first screen forms a first stage and is operatively attached to the second screen which forms a second stage, such that the moveable rake element is adapted to rake both screens. The rake element includes a wiping member adapted to wipe the upper surface of the second screen.

The present invention relates to a staged screen system, for the removal of debris from a fluid flow. This invention is directed particularly but not solely towards to staged screen for the removal of debris from a waste water treatment flow.

### BACKGROUND

Solids and floatables or any unwanted debris in a fluid flow need to be removed for a variety of reasons such as improving the fluid flow capacity, allowing the more efficient treatment of the fluid and allowing the flow to flow unimpeded. Extra debris which may also cause flooding can increase the fluid flow volume.

Fixed or moveable screens are used to stop and remove coarse solids or non-fluid debris from any fluid flow. These screens are commonly seen as fixed gratings with spaced apart bars. Fixed screens are difficult to install, difficult to maintain and difficult to remove any debris there from. Often fixed screens have to single handedly cope with a variety of flow types which means that they are quickly overwhelmed.

Removing debris from fixed or movable screens is a time consuming operation. Often manual labour is involved requiring specialist skills to adequately and safely remove any debris. Existing mechanical screens are often overly complicated requiring extensive on-going maintenance and replacement.

This sort of screening does not tend to cover the need to remove fine debris from fluid flows. Coarse screening or inadequate upstream screening can cause variable discharge from the flow and also cause high transient loadings and increased head loss in the flow.

### OBJECT OF THE INVENTION

It is therefore an object of the present invention to provide an improved staged screen system which at least ameliorates some of the aforementioned problems and/or provides the public with a useful choice.

### STATEMENT OF THE INVENTION

Accordingly in one aspect the invention consists in a staged screen system for the removal of solids or floatables or any unwanted debris from a suspension or fluid flow, the system comprising an apparatus including at least a first screen, at least a second screen and at least one moveable rake means wherein the first screen which forms a first stage, is operatively attached to the second screen which is forms a second stage, such that the moveable rake means is adapted to rake both screens.

Preferably the apparatus in use has a length, width, height and entry end and exit end, the first screen has an upper and lower surface and the second screen has an upper and lower surface wherein the first screen is located in a spaced apart orientation with respect to the second screen and the first screen lower surface faces the second screen upper surface.

Preferably the first screen and second screen are interconnected by a frame.

Preferably the first screen includes a plurality of vertical members spaced apart forming slots there between.

Preferably each rake means includes a plurality of tines sized and spaced to slidably interfit in between each screen member, wherein the tines have an upper and lower end and said tines extend across the first screen width defining outermost tines.

Preferably each rake means is suspended above the first screen at a suitable distance to enable raking in a static mode or a moving or rotating mode.

Preferably the tines are interconnected by a horizontal shaft which can be connected and movably supported via the frame.

Preferably the shaft is operatively connected to a drive means and the frame can interconnect the screen and drive means.

Preferably the tines have a length at least equal to depth of the first screen.

Preferably the drive means moves the rake along the length of the apparatus in a forward and reversing direction.

Preferably the tines can be fixed or moveable relative to the shaft.

Preferably the tines can be set to be down when travelling up the screen or in a first direction to remove debris and be in the up position or second direction when returning or going back down to the start position.

Preferably the rake means includes a wiping means adapted to wipe the upper surface of the second screen in a static mode or rotatable mode which can be separately controlled or be in synchronized mode with the rake.

Preferably the wiping means is connected to the lower end of the rake means, being located in a space between the first and second screens wherein the tines extend such that in use they can wipe any debris from the second screen.

Preferably the wiping means is rotatably connected at least to the outer tines of the rake means.

Preferably in use the apparatus is placed in a flow such that any debris can be obstructed and held in the screens, whereby the rake means is driven from the entry end to the exit end, this being a driven stroke.

Preferably the wiper has a stop means to enable the wiping means to be wiping in the driven stroke but to float in the backward or reversed direction.

Preferably the first screen vertical members can be formed of a T-section having dimensions such that any coarser solids can be efficiently and adequately removed there between.

Alternatively the screen members can be L-shaped or I-shaped.

Preferably the first screen can be fabricated from stainless steel.

Preferably the second screen can be fabricated from a plastic material.

Preferably the apparatus includes a discharge plate to facilitate the removal of any solids from the fluid flow.

Preferably the second screen has a plurality of apertures or slots extending from the upper surface to the lower surface, that are dimensioned and sized and spaced to enable the removal of fluid and/or less coarser solids from the incoming fluid flow.

Preferably the wiping means includes a holding means and wiper.

Preferably the wiper has a serrated edge.

### BRIEF DESCRIPTION OF DRAWINGS

Embodiments of the invention will now be described by way of example only, with reference to the accompanying drawings of which;

FIG. 1 is a perspective view of the discharge end of the apparatus excluding any supporting frame.

FIG. 2 is another perspective view of an alternative discharge end of the apparatus excluding any supporting frame.

FIG. 3 is a side elevation of the apparatus.

FIG. 4 is a plan view of the apparatus of FIG. 3.

FIG. 5 is a plan view of the frame itself.

FIG. 6 is a side elevation view of the frame of FIG. 5.

FIG. 7 is an end view of the frame as shown in FIGS. 5 and 6.

FIG. 8 is another end view of the frame and rakes of the apparatus.

FIG. 9 is a side view of the wiper holding means.

FIG. 10 is a cross-sectional view of the wiper holding means of FIG. 9.

FIG. 11 is a side view of the wiper blade.

FIG. 12 is an end view of the wiper blade of FIG. 11.

### DETAILED DESCRIPTION OF THE INVENTION

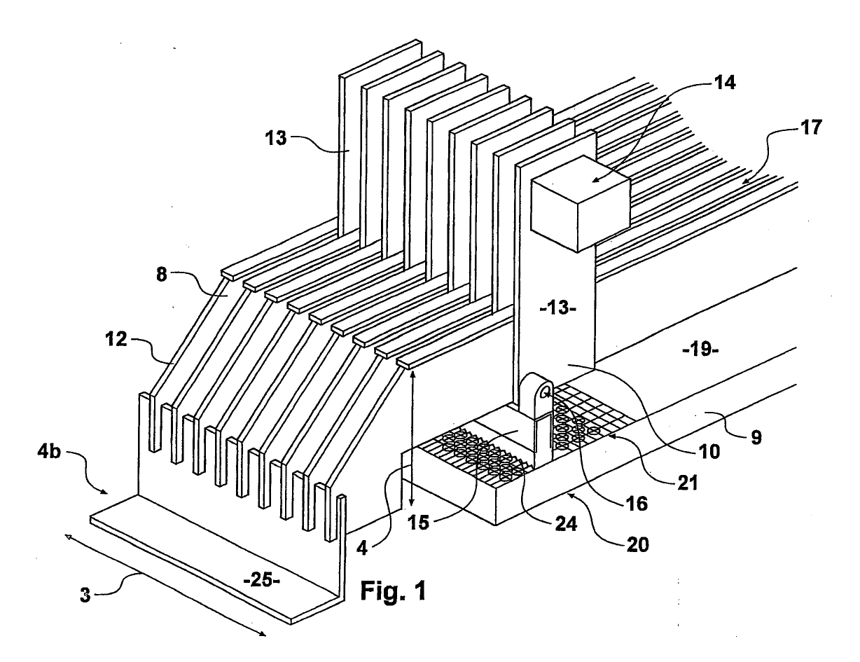

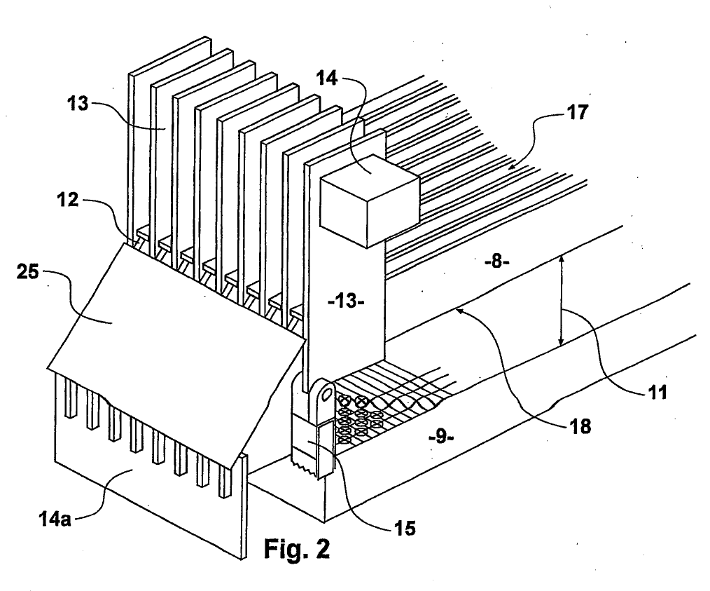

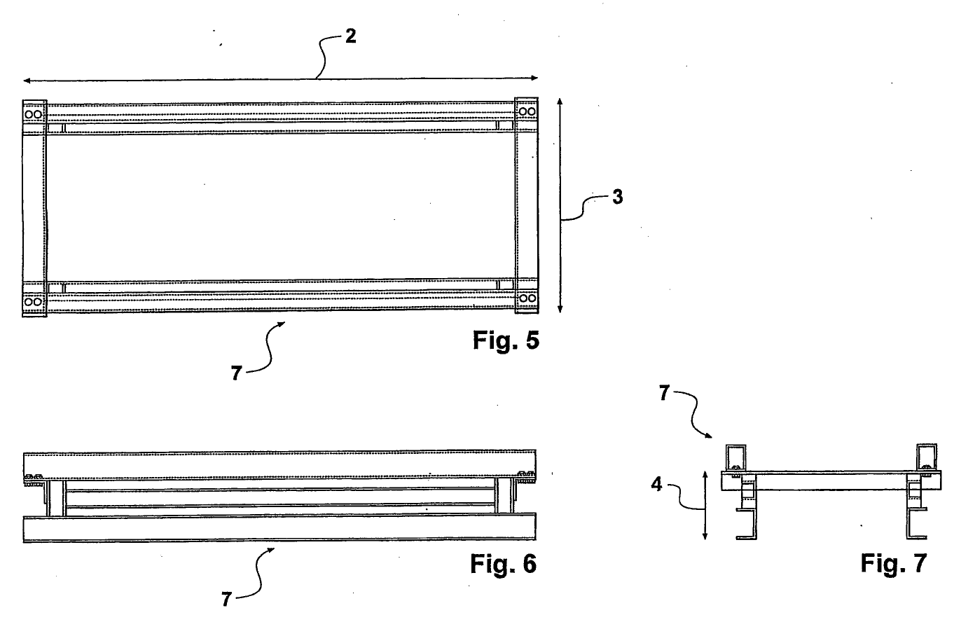

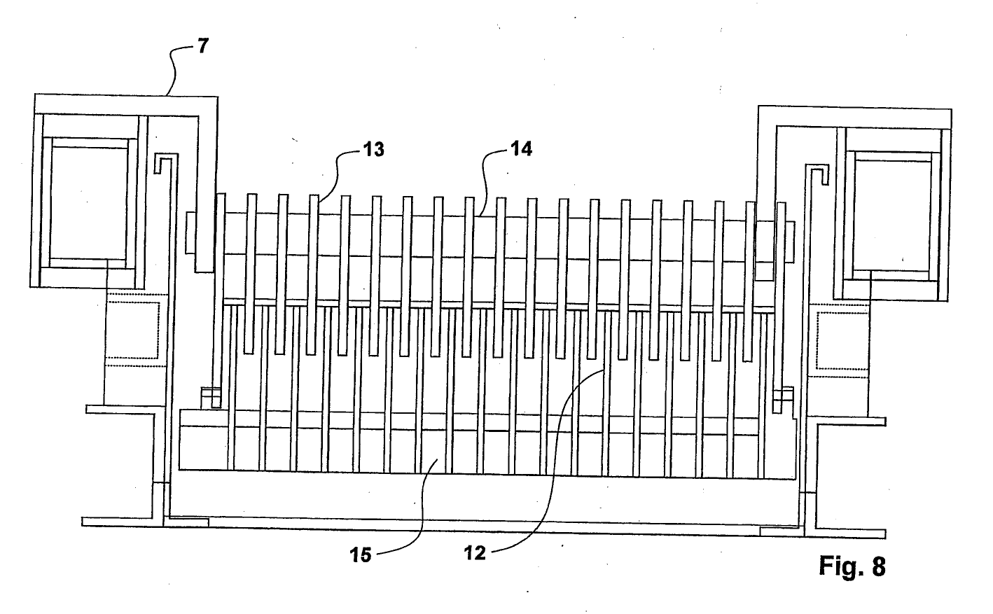

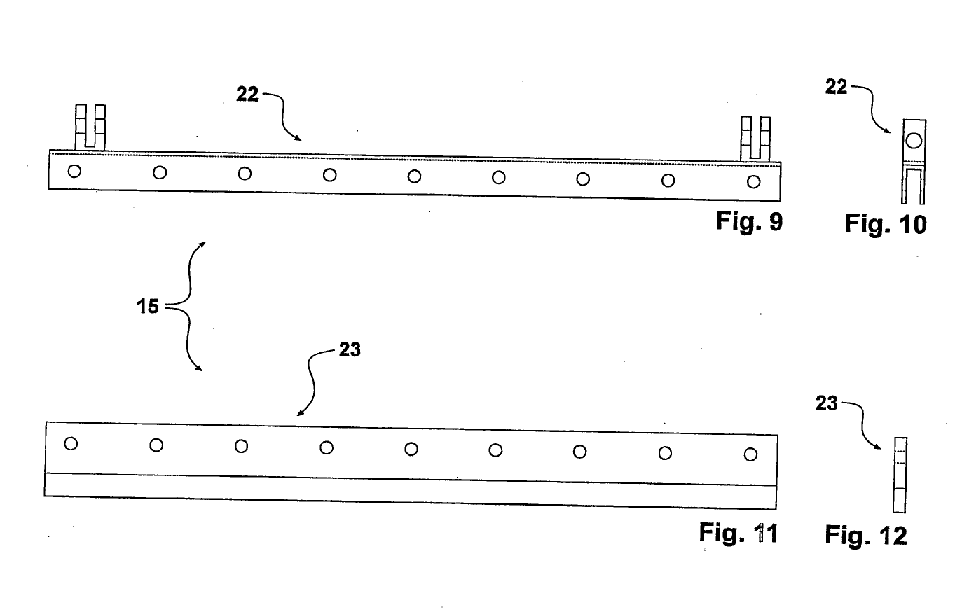

FIGS. 1 to 12 show an example of the staged screen system. For example, a two staged screen system includes an apparatus 1 which can be placed in any fluid flow. A first screen or primary screen will discharge its filtrate directly onto a second screen or secondary screen over at least part of its full length. The accepted filtrate will pass through the second screen to then be discharged. The fluid flow can be a suspension having solids or floatables and/or debris therein that needs to be removed. The fluid flow can be any fluid that requires the solids to be removed as is needed in any waste water treatment system.

The apparatus 1 can have a length 2, width 3 and height 4 and entry end 4a and an exit end 4b which can be defined in relation to its use in a fluid flow. The length 2 is deemed to be substantially parallel to the direction of flow and the other dimensional characteristics being defined accordingly, though other uses in terms of position and orientation are equally possible.

The apparatus is adapted is rest on any support surface (not shown) such as the base of a waste water channel or any space that needs removal or separation of unwanted material from a volume of fluid and non fluid. The base can define a horizontal plane 5 and the apparatus can be orientated at any selected angle 6 to this plane 5. For example this angle can be 45 degrees to facilitate an efficient flow of debris from the flow and on to the apparatus 1.

Apparatus 1 has a frame 7, a first screen 8, a second screen 9 and a rake 10. The first screen performs the first stage and the second screen carries out the second stage. In use first screen 8 is spaced above the second screen by a selected dimension 11. This space can be constant or angled or varied as required. The frame 7 interconnects the first 8 and second screens 9. Rake 10 is operatively supported by frame 7. First screen 8 includes a structure having in use a plurality of upright spaced apart screen members 12. These screen members 12 form slots that can have any suitable shape or dimensions and spacing 12a that allows removal of the debris there between. For example elements 12 can be ‘T’ or ‘L’ or ‘I’ or wedge shaped etc. As shown the screen members 12 are shown in a substantially vertical orientation but other variations are equally possible which can be set up manually or during construction or this can included as an adjustment means.

The rake 10 includes a plurality of spaced apart tines or slender members 13 supported by a shaft 14 and support plate 14a at the ends. Included in or with the rake 10 is a wiping means 15. The wiping means 15 is pivotally 16 connected to a lower end of the outer-most tines 13 of the rake 10. The tines 13 are spaced and sized such that they slidally interfit within the spacing of the vertical screen members 12 in an alternating fashion such that all spaces can be raked by each tine 13. This means that every space between screen members 12 has at least one tine 13 that can rake there-through to push any debris to a selected position. The tines can be any shape that is able to fit between the vertical elements to rake any unwanted material thereon or therein. The spacing between tines and between screen members 12 can be varied as required both operatively or in a static sense.

The wiping means 15 is dimensioned to fit within the space 11 between the first or primary screen 8 and the second or secondary screen 9. First screen 8 has an upper and lower surface 17 and 18. Second screen 9 has upper and lower surfaces 19 and 20. The space 11 is the clear space between the lower surface 18 of the first screen 8 and upper surface 19 of the second screen. The second screen 9 has a plurality of spaced apart slots or apertures or perforations 21 which extend from the upper surface 19 of the second screen 9 to the lower surface 18 of the first screen 8. For example the perforations 21 can be sized at entry as 4 mm to 7 mm at the exit point.

The spacing 12a of the members 12 of the vertical screen members can be set to be greater than that of the size spacing and diameter of the slots 21. The first or primary screen 8 can be termed a coarse screen and the second or secondary screen 9 can be termed a fine screen.

The wiper means 15 can include a holding portion 22 and wiper blade portion 23. The holding portion 22 can be slotted to allow for the insertion and holding of the wiper blade 23. The wiper blade 23 can be fabricated from any suitable material that allows the scalping of upper surface 19 of second screen 9. A distal surface edge 24 of the wiper blade can be serrated to further facilitate the scalping or removal of solids from upper surface 19 of second screen 9.

Alternatively wiper means 15 function could be replaced or combined with by allowing the rake tines 13 to have downwardly extended portions that can be allowed to be extendable as required. The extended portion (not shown) can extend to the upper surface 19 of second screen 9. As above, the tines can be set to be permanently set in the down position during use or at all times. The tines can have retractable portions or be retractable both manually and/or automatically. In use in one example, the tines can be set to be down only in the driven stroke and be in the up position during the down or floating direction. Other modes of operation are equally possible.

A deflecting means 25 can be removably attached to at least the exit end of the frame 7. The deflecting means 25 cain be a discharged plate supported by a support plate 25a attached to the end of the tines at the exit end of the frame.

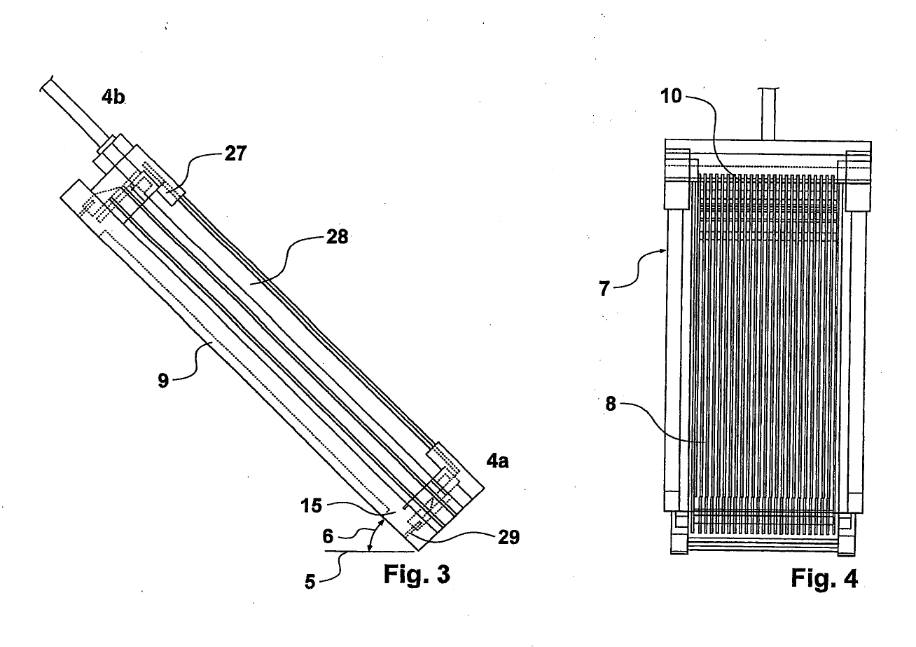

A drive means 26 as shown in FIG. 3 serves to remove each rake 10 across and through the length of the tines 13. The drive means 26 can be a hydraulically operated cylinder or ram, though other operating systems such as mechanical means combined with electricity are equally possible. These systems can be remotely or non-remotely controlled and programmed. Other parts of the drive means can include bearings 27, bearing guides 28, primary screen support 29 as shown in FIGS. 3 and 4.

In operation—the apparatus is placed within a fluid flow at a selected angle 6. For example this angle can be at a 45 degree angle to the base 5 of the channel. This angle further facilitates the entry of any fluid that has debris therein that need to be removed. To remove the debris from the fluid flow the rake is driven up the frame 7 from the entry end to the exit end whereby the tines 13 slide through between the screen elements 12 to push solids to the upper end of the frame 7 which are then discharged over the discharge plate 25 to any suitable collection means. Tines 13 can be used in a static mode or can be rotated to retract as required with or without wiping means 15.

During the travel of tines 13 up the frame 7 the wiper blade 24 at the same time is scalping the upper surface 19 of the second screen 9. The larger solids will be collected by the primary screen 8, smaller diameter solids and fluid will be collected by the upper surface 19 of the lower screen 9 such that the wiper 24 will force any solids through the slots 21 and apertures or perforations of the lower screen 9.

The captured solids from both the primary and secondary screens can be conveyed upwards to a common discharge position at the head of the stage screen or end of the stroke.

In the downward part of the stroke being the return cycle back to the start of the apparatus, the duration of the stroke can be set at one third of the time of the up stroke which collects or screens any debris.

The staged screen system is able to remove larger screenable items on first screen (first stage) and filtrate can drop through to the lower second screen (second stage) and remove any particulate not already remove by the first screen.

The frame as shown in FIG. 5-7 can include as shown various profiles such as for example, angle end members and longitudinal channel members with RHS members making up the frame. This frame can include lifting and moving portions (not shown) to, enable easy installation and removal and portions that enable any orientation with respect to waterway base and waste water to be achieved. The parts can be removably connected further facilitating repair and modification. The frame can be fabricated from stainless steel or aluminium or steel or any material that can be coated appropriately to withstand the weather and chemical and physical attack from the wastewater flow.

In operation, we can term the upward movement or driving of the tines 13 as being the forward stroke, whereby the unwanted solids or debris in the flow is pushed and or moved to an exit or removal point or discharge end at end 4b. The backward stroke being the reverse can be used to travel back to the entry end of the apparatus to repeat the forward movement. The drive means 26 in the reverse action is not used, though there may be options where the tines 13 can be both driven up and drive down the frame 7. In this particular example we can have the backward stroke accomplished by merely allowing the tines and wiping means to ‘float’ back to the entry end of the apparatus.

There are many variations that are possible with any or all of the components of the screen system. For example the number of rakes 10 that can be driven up the frame 7 can be varied. There could one there could be two or there could be a plurality of rakes 10. Also the speed of driving can be varied according to the slope that needs to be traversed or the length of the frame 7 that is required. The wiper can be continuous along the width of the primary screen or apparatus or it may be gapped or perforated or can be a series of separate vertical fins or it may include or be part of a brushes or foam material system. There may be separate fins separately and removably attached to the fixed elements 12 by any fixing means such as bolting, screwing, welding, etc. In another variation the wiper can be a static item(s) or it can be movably operated as required or be synchronized with the operation of the rake 13 which can also be a static item or be movable.

The dimensions of the apparatus which include the size of the apparatus in general that is the length, width, and height, can be varied to suit particular channels, waste water channels or capacity of fluid flows being operated with the spacing, size and shape of the tines 13, the vertical screen members 12 and holes 21 can be varied. Holes 21 of secondary screen 9 can also be varied according to need or cost. The holes 21 can be tapered or flared with the smaller diameter being at the top or upper surface 19, to further facilitate removal of solids and or non solids etc and allowance of fluid flow there-through. The spacing of the screen elements can 6 mm and the head of screen elements may be about 10 mm and also have a height of 30-40 mm.

Also in another variation the staged screen system can be varied by adding further screens so that different situations can also be covered. The primary screen can spaced from the secondary screen by any selected dimensions. For example, the spacing may be constant or uneven or irregular or greater or less, at one end. The discharge structure can be varied in that the discharge plate may not be necessary and screen elements 12 may not overhang the second screen 9. In another variation screen elements may form a substantially vertical end face or they may be angled or recessed back towards the system to further facilitate discharge and removal of any debris.

The primary and secondary screens can be fabricated from any variety of materials. For example the primary screen could be fabricated from stainless steel and the secondary screen from a plastics material like for example polyurethane or acetal. The particular type of material will depend on both cost and practicality of use. For example some types of material useful in this system are brass or SS316.

Underneath the second stage screen the system design allows for the optional installation of air fan nozzles to assist the in the cleaning of the perforated screen. This can be useful for removing fats and or grease etc.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

Throughout the description and claims of this specification the word “comprise” and variations of that word, such as “comprises” and “comprising”, are not intended to exclude other additives, components, integers or steps.

The staged screen system may have at least some of the following advantages:
1. Efficient operation.
2. Simple operation.
3. Modest manufacturing and operating costs.
4. Automatic operation.
5. Minimal maintenance requirement.
6. Easy installation.
7. Robust construction.
8. Consistent discharge flow after screening.
9. Increased fluid flow capacity.
10. Effective fine screening to reduce head loss.
11. Clears coarse debris or particulate material from a fluid flow.

1-26. (canceled)

27. A staged screen system for the removal of solids or floatables or any unwanted debris from a suspension or fluid flow, the system comprising an apparatus including at least a first screen, at least a second screen and at least one moveable rake means wherein the first screen being a first stage, is operatively attached to the second screen which forms a second stage, such that the moveable rake means is adapted to rake both screens wherein the rake means includes a wiping means adapted to wipe the upper surface of the second screen.

28. A staged screen system as claimed in claim 27 wherein the apparatus in use has a length, width, height and entry end and exit end wherein the first screen has an upper and lower surface and the second screen has an upper and lower surface wherein the first screen is located in a spaced apart orientation with respect to the second screen and the first screen lower surface faces the second screen upper surface.

29. A staged screen system as claimed in claim 28 wherein the first screen and second screen are interconnected by a frame.

30. A staged screen system as claimed in claim 29 wherein the first screen includes a plurality of screen members spaced apart forming slots there between.

31. A staged screen system as claimed in claim 30 wherein each rake includes a plurality of tines sized and spaced to slidably interfit in between each screen member, wherein the tines have an upper and lower end and said tines extend across the first screen width defining outermost tines.

32. A staged screen system as claimed in claim 31 wherein each, rake means is suspended above the first screen at a suitable distance to enable raking in a static mode or a moving or rotating mode.

33. A staged screen system as claimed in claim 32 wherein the tines are interconnected by a horizontal shaft which can be connected and movably supported via the frame.

34. A staged screen system as claimed in claim 33 wherein the shaft is operatively connected to a drive means wherein the frame can interconnect the screen and drive means.

35. A staged screen system as claimed in claim 34 wherein the tines have a length at least equal to depth of the first screen.

36. A staged screen system as claimed in claim 35 wherein the drive means moves the rake along the length of the apparatus in a forward and reversing direction.

37. A staged screen system as claimed in claim 36 wherein the tines can be fixed or moveable relative to the shaft.

38. A staged screen system as claimed in claim 37 wherein the tines can be set to be down when travelling up the screen to remove debris and be in the up position when returning or going back down to the start position.

39. A staged screen system as claimed in claim 38 wherein the wiping means is adapted to wipe the upper surface of the second screen in a static mode or rotatable mode which can be separately controlled or be in synchronized mode with the rake means.

40. A staged screen system as claimed in claim 39 wherein the wiping means is connected to the lower end of the rake means, being located in a space between the first and second screens and the tines extend such that in use they can wipe any debris from the second screen.

41. A staged screen system as claimed in claim 40 wherein the wiper is pivotally connected and supported at, at least to the outer tines of the rake means to enable both rotation or retraction in conjunction with or without the tines.

42. A staged screen system as claimed in claim 41 wherein in use the apparatus is placed in a flow such that any debris can be obstructed and held in the screens, whereby the rake means is driven from the entry end to the exit end, this being a driven stroke.

43. A staged screen system as claimed in claim 42 wherein the wiper has a stop means to enable the wiping means to be wiping in the driven stroke but to float in the backward or reversed direction.

44. A staged screen system as claimed in claim 43 wherein the first screens vertical members can be formed of a T-section having dimensions such that any coarser solids can be efficiently and adequately removed there between.

45. A staged screen system as claimed in claim 44 wherein the vertical members can be L-shaped or I-shaped.

46. A staged screen system as claimed in claim 45 wherein the first screen can be fabricated from stainless steel.

47. A staged screen system as claimed in claim 46 wherein the second screen can be fabricated from a plastic material.

48. A staged screen system as claimed in claim 47 wherein the apparatus includes a discharge plate to facilitate the removal of any solids from the fluid flow.

49. A staged screen system as claimed in claim 48 wherein the second screen has a plurality of apertures or slots extending from the upper surface to the lower surface, that are dimensioned and sized and spaced to enable the removal of fluid and/or less coarser solids from the incoming fluid flow.

50. A staged screen system as claimed in claim 49 wherein the wiping means includes a holding means and wiper.

51. A staged screen system as claimed in claim 50 wherein the wiper has a serrated edge.
